(19) United States
(12) Patent Application Publication
(10) Pub. No.: US 2005/0061497 A1
(43) Pub. Date: Mar. 24, 2005

(54) Temperature control device for motor vehicle, for example electrical or hybrid

(76) Inventors: Manuel Amaral, Paris (FR); Pierre Dumoulin, Les Moulineux (FR)

Correspondence Address: James R Williams;Jameson Seltzer Harper & Williams, 2625 Wilmington Road, New Castle, PA, 16105, US

(21) Appl. No.: 10/492,573

(22) PCT Filed: Oct. 11, 2002
(86) PCT No.: PCT/FR02/03491

(30) Foreign Application Priority Data
Oct. 12, 2001 (FR) 01/13154

(51) Int. Cl. B60H 1/00

(52) U.S. Cl. 165/202

(57) ABSTRACT

The temperature regulation device (10) comprises a heat pump (12) having a main refrigerant fluid circuit (14) taking heat from a cold source (16) and transferring it to a hot source (18), the cold source (16) including a refrigerant fluid/air heat exchanger (26) designated as first evaporator. The cold source (16) also comprises a refrigerant fluid/coolant liquid heat exchanger (28) designated as second evaporator (28), thermally coupling the main refrigerant fluid circuit (14) to a secondary coolant liquid circuit (38) capable of being connected at least to a first secondary heat exchanger (42, 44) in heat exchange with a first heat source of the vehicle. The first and second evaporators (26, 28) being connected in parallel.

The present invention relates to a temperature regulation device for a motor vehicle, e.g. of the electrical or hybrid type.

A hybrid type vehicle combines two sources of energy for propulsion purposes: an electric motor and a heat engine. In an electrical or hybrid type vehicle, the electric motor is powered by a battery and controlled by an electronic power device.

Proper operation of the battery depends on the temperature of the air surrounding the battery, and in particular on ambient temperature outside the vehicle. In general, the battery is deactivated when its temperature exceeds a maximum value of about 55° C. However battery lifetime can be increased by further restricting its maximum temperature, for example to avoid said maximum temperature exceeding 35° C., as much as possible.

It is known that the battery can be cooled by means for causing a flow of air to circulate in contact with the battery. As a general rule, the battery cooling air comes from the vehicle cabin. The means for air conditioning the cabin thus contribute to cooling the battery. In a variant, the battery cooling air can come from outside the vehicle.

Thus, in the state of the art, a temperature regulation device is already known for a motor vehicle, the device being of the type comprising a heat pump having a main refrigerant fluid circuit taking heat from a cold source and transferring it to a hot source, the cold source including a refrigerant fluid/air heat exchanger designated as first evaporator.

The evaporator is conventionally constituted by a refrigerant fluid/air heat exchanger arranged in the cabin for cooling the air of the cabin. Air taken from the cabin serves to cool the battery.

As with the battery, it is also appropriate to limit the temperature of the electronic power device.

It is known to cool the electronic power device by means of a coolant liquid circuit (generally a mixture of water and antifreeze) connected to a coolant liquid and air heat exchanger arranged in the front face of the vehicle. At the outlet from the heat exchanger, the temperature of the coolant liquid is generally lowered to about 60° C. Nevertheless, the volume and the cost of the electronic power device could be reduced by further reducing the temperature of the coolant liquid for cooling said device, e.g. down to 20° C.

The invention seeks in particular to optimize firstly operation and lifetime of the battery and secondly bulk and cost of the electronic power device, while modifying as little as possible the configuration of the engine compartment and of the means for air conditioning the vehicle cabin.

To this end, the invention provides a motor vehicle temperature regulation device of the above-specified type, characterized in that the cold source also comprises a refrigerant fluid/coolant liquid heat exchanger designated as second evaporator, thermally coupling the main refrigerant fluid circuit to a secondary coolant liquid circuit capable of being connected at least to a first secondary heat exchanger in heat exchange with a first heat source of the vehicle, the first and second evaporators being connected in parallel.

According to characteristics of various embodiments of the device:
the second secondary coolant liquid circuit is suitable for being connected to a second secondary heat exchanger in heat exchange with a second heat source of the vehicle;
the first and second secondary heat exchangers are connected in parallel in the secondary coolant liquid circuit;
the main refrigerant fluid circuit comprises first and second parallel evaporator branches connected respectively to the first and second evaporators, each evaporator branch including a respective expansion valve disposed downstream or upstream from the evaporator;
the first evaporator branch includes a valve for regulating the fluid flow rate and preferably disposed downstream from the first evaporator;
the expansion valve and the regulation valve in the first evaporator branch constitute a single member;
the secondary cooling liquid circuit is provided with a pump for driving said cooling liquid;
the hot source includes a refrigerant fluid/air heat exchanger designated as condenser, preferably disposed in the engine compartment of the vehicle;
the first evaporator of the cold source is disposed in a cabin of the vehicle;
the second evaporator of the cold source is disposed in a portion of the vehicle that is distinct from the cabin;
each secondary heat exchanger is disposed in a portion of the vehicle that is distinct from the cabin;
each hot source is selected from an exothermal member of the vehicle, such as a member forming an electronic power device, a power supply battery for an electrical vehicle drive motor, or a fuel cell, and the air for supercharging a heat engine of the vehicle;
the refrigerant fluid of the main circuit is of the R134a type;
the refrigerant fluid of the main circuit comprises carbon dioxide;
the main circuit includes an intermediate heat exchanger having passing therethrough both a branch of the main circuit upstream from the compressor and a branch of the main circuit downstream from the condenser; and
the coolant liquid of the secondary coolant liquid circuit is a mixture of water and antifreeze.

The invention will be better understood on reading the following description given purely by way of example and made with reference to the accompanying drawings, in which:

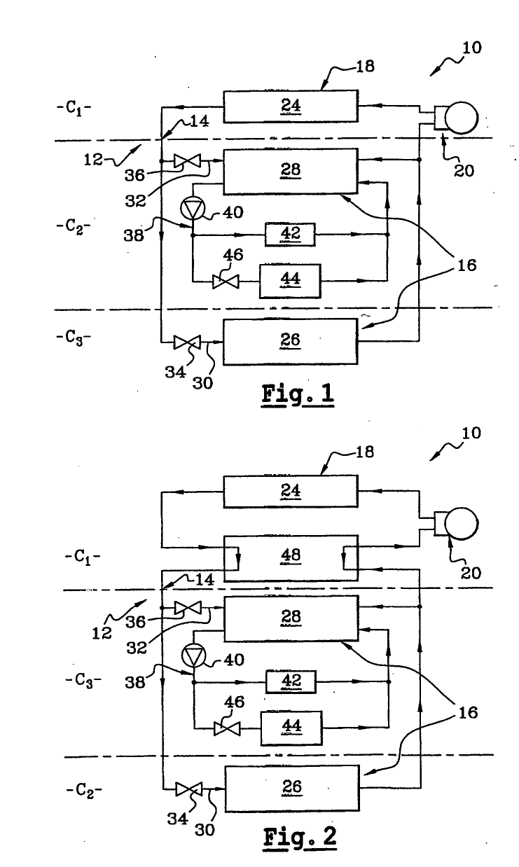

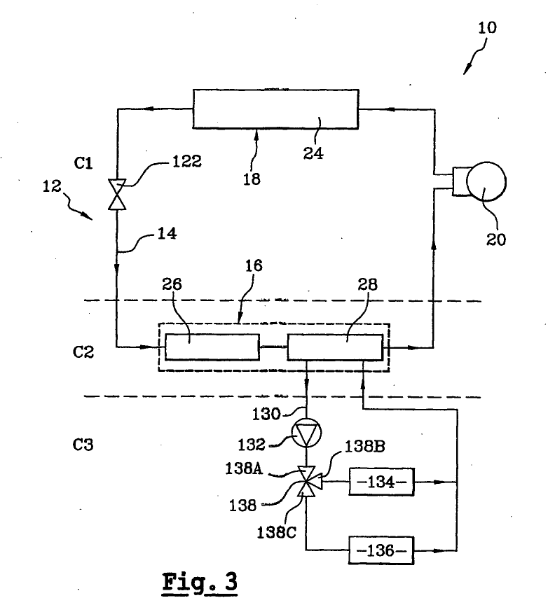

FIGS. 1 and 2 are block diagrams of a temperature regulation device constituting two respective embodiments of the invention; and

FIGS. 3 to 5 are diagrammatic views of a temperature regulation device constituting three respective other embodiments.

FIG. 1 shows a temperature regulation device for a motor vehicle, in particular of the electrical or hybrid type, constituting a first embodiment of the invention. This temperature regulation device is designated by overall reference 10.

In the text below, two members are said to be thermally coupled together when they exchange heat between each other by means of a suitable heat exchanger.

The temperature regulation device 10 comprises a heat pump 12 comprising a main compression type refrigerant fluid circuit 14 taking heat from a cold source 16 and transferring at least some of to it to a hot source 18.

The cold and hot sources 16 and 18 are connected to each other by a compressor 20 (electrical or mechanical). The refrigerant fluid vaporizes, taking heat from the cold source 16. The compressor 20 sucks in the vaporized fluid and delivers it towards the hot source 18 where it condenses while cooling down. The refrigerant fluid flow direction in the main circuit 14 is shown by arrows in FIG. 1. The refrigerant fluid flowing in the main circuit 14 is of conventional type. The refrigerant fluid is selected, for example, from a chlorine and fluorine-containing derivatives of methane or ethane (Freon), a hydrocarbon, a hydrofluorocarbon (HFC), ammonia, etc.

In the example described, the refrigerant fluid is R134a (HFC).

By way of example, the hot source 18 comprises a refrigerant fluid/air heat exchanger 24 designated as condenser.

The compressor 20 and the condenser 24 are arranged in a compartment C1 of the vehicle that preferably constitutes the engine compartment of the vehicle. By way of example, the condenser 24 is arranged in a front face of the vehicle.

The cold source 16 comprises a refrigerant fluid/air heat exchanger 26 designated as first evaporator, and a refrigerant fluid/coolant liquid heat exchanger 28 designated as second evaporator.

These first and second evaporators 26 and 28 are connected respectively to first and second parallel evaporator branches 30 and 32 of the main refrigerant fluid circuit 14. The first and second evaporators 26 and 28 are thus connected in parallel.

Each evaporator branch includes a respective expansion valve 34, 36 (a calibrated orifice thermostatic or electronic valve) disposed downstream from the evaporators 26, 28, as shown in FIG. 1, or upstream from the evaporators 26, 28. Each expansion valve 34, 36 allows the refrigerant fluid to pass towards the corresponding evaporator 26, 28 by lowering its pressure.

The first evaporator branch 30 includes a fluid flow regulation valve, in particular of the on/off type, preferably disposed downstream from the first evaporator 26. In the example shown, this regulation valve and the expansion valve of the first branch 30 are constituted by a single member 34.

The second evaporator 28 thermally couples the main refrigerant fluid circuit 14 to a secondary coolant liquid circuit 38. The circuit 38 includes a pump 40, preferably an electrical pump, for circulating the coolant liquid, and connected in the example shown to an output of the second evaporator 28. In a variant, the pump 40 could be disposed upstream from the second evaporator 28.

The coolant liquid of the secondary circuit 38 is, for example, a mixture of water and antifreeze.

The direction in which the coolant liquid circulates in the secondary circuit 38 is shown by arrows in FIG. 1.

The secondary circuit 38 may be connected firstly to a first secondary heat exchanger 42 in heat exchange with a first exothermal member of the vehicle, and secondly to a second secondary heat exchanger 44 in heat exchange with a second exothermal member of the vehicle.

The first and second secondary heat exchangers 42 and 44 are connected in parallel in the secondary coolant liquid circuit 38. It should be observed that the branch of the secondary circuit 38 to which the second secondary heat exchanger 44 is connected includes a valve 46 for regulating the flow of the coolant liquid, in particular an on/off type valve, preferably disposed downstream from said secondary heat exchanger 44.

In the example described, the first exothermal member in heat exchange with the heat exchanger 42 is constituted by an electronic power device for controlling an electric motor for driving the vehicle. In addition, the second exothermal member in heat exchange with the heat exchanger 44 is constituted by a power supply battery for the electric motor of the vehicle.

In a variant, the secondary coolant liquid circuit 38 could be connected to a single secondary heat exchanger, for example the heat exchanger 44 in heat exchange with the battery.

It should be observed that in the invention the exothermal members in heat exchange with the heat exchangers 42 and 44 could be any exothermal members.

The first evaporator 26 is disposed, for example, in a compartment C2 of the vehicle constituting a vehicle cabin, and more particularly a cabin air conditioner unit. The second evaporator 28 and the two secondary heat exchangers 42 and 44 are disposed, for example, in a compartment C3 of the vehicle that is distinct from the cabin. By way of example, the compartment C3 may be formed by the engine compartment (in which case the compartments C1 and C2 are identical, or by a compartment disposed beneath the floor of the vehicle cabin).

The main aspects of the operation of the temperature regulation device 10 of the invention are described below.

a) Operation of the Temperature Regulation Device 10 in Cold Conditions

When the vehicle is started, the exothermal members in heat exchange with the heat exchangers 42 and 44 do not need to be cooled since their temperature is sufficiently low. Similarly, the vehicle cabin has no need to be cooled.

As a result, the heat pump 12 and the pump 40 of the secondary coolant liquid circuit 38 are deactivated.

After the electric motor of the vehicle has been operated for a certain length of time, the temperature of the exothermal members in heat exchange with the heat exchangers 42, 44 rises. The heat pump 12 and the pump 40 of the secondary circuit 38 are then activated. The valve 46 enables the cooling of the exothermal member associated with the second secondary heat exchanger 44 to be adjusted in accordance with requirements. The compressor 20 operates at a low rate that is sufficient for removing heat coming from the exothermal members and the secondary circuit 38 to the hot source 18 of the heat pump.

The valve 34 enables cooling of the cabin to be adjusted in accordance with requirements.

Where appropriate, the compressor 20 operates at a faster rate in order to enable the cabin to be cooled via the first evaporator 26 that is disposed in said cabin.

b) Operation of the Temperature Regulation Device 10 in Hot Conditions

Under such circumstances, the compressor 20 generally operates at a high rate so as to cool firstly the cabin via the first evaporator 26 and secondly the exothermal members via the second evaporator 28.

If during operation of the vehicle it is no longer necessary to cool the exothermal members, the pump 40 is deactivated.

FIG. 2 shows a temperature regulation device constituting a second embodiment of the invention. In FIG. 2, elements that are analogous to those of FIG. 1 are designated by references that are identical.

In this second embodiment of the invention, shown in FIG. 2, the refrigerant fluid of the main circuit 14 comprises carbon dioxide.

The main circuit 14 includes a conventional intermediate heat exchanger 48 with a branch of the main circuit 14 upstream from the compressor 20 and a branch of the main circuit 14 downstream from the condenser 24 passing therethrough.

Amongst the advantages of the invention, it should be observed that the secondary coolant liquid circuit 38 coupled to the heat exchanger 12 by the second evaporator 28 enables the battery and the electronic power device of an electrical or hybrid vehicle to be cooled effectively. As a result, the maximum temperature of the battery can be restricted so as to increase the lifetime of the battery. Furthermore, the temperature of the coolant liquid in heat exchange with the electronic power device can be lowered effectively compared with a conventional temperature regulation device so as to enable the volume of said electronic device to be significantly reduced.

Under hot conditions, the secondary coolant liquid circuit 38 thermally coupled to the cold source 16 of the heat pump enables the temperature of the battery to be cooled quickly so as to stabilize it at a value of about 35°, thereby guaranteeing a relatively long lifetime for the battery.

The reaction time of the batteries on a hot start can be reduced.

The invention thus makes it easier to use electrical or hybrid vehicles in hot regions.

Finally, the invention can be fitted to existing vehicles without significantly altering the configuration of the engine compartment and of the means for air conditioning the cabin of such a vehicle.

FIGS. 3 to 5 show temperature regulation devices constituting third to fifth embodiments of the invention, respectively. In these figures, elements analogous to those of the preceding figures are designated by references that are identical.

In FIG. 3, the cold and hot sources 16 and 18 are interconnected by the compressor 20 and an expansion valve 122. The refrigerant fluid circulating in the main circuit 14 is of a conventional type. This refrigerant fluid is selected, for example, from a chlorine- and fluorine-containing derivative of methane or ethane (Freon), a hydrocarbon, ammonia, carbon dioxide, etc.

The compressor 20, the expansion valve 122, and the condenser 24 are disposed in a compartment C1 of the vehicle.

The second evaporator 28 thermally couples the main refrigerant fluid circuit 14 to a secondary coolant liquid circuit 130. This circuit 130 includes a pump 132, preferably an electrical pump, for circulating the coolant liquid, and connected in the example shown to an output of the second evaporator 28. In a variant, the pump 132 could be disposed upstream from the second evaporator 28.

By way of example, the coolant liquid of the secondary circuit 130 is a mixture of water and antifreeze.

The secondary circuit 130 can be connected firstly to a first secondary heat exchanger 134 in heat exchange with a first exothermal member of the vehicle, and secondly to a second secondary heat exchanger 136 in heat exchange with a second exothermal member of the vehicle.

The first and second secondary heat exchangers 134 and 136 are connected in parallel in the cooling liquid secondary circuit 130.

In the example described, the first exothermal member in heat exchange with the heat exchanger 134 is constituted by an electronic power device for controlling an electric motor that drives the vehicle. Furthermore, the second exothermal member in heat exchange with the heat exchanger 136 is formed by a battery for powering the electric motor of the vehicle.

In a variant, the cooling liquid secondary circuit 130 could be connected to a single secondary heat exchanger, e.g. the heat exchanger 136 in heat exchange with the battery.

It should be observed that in the invention the exothermal members in heat exchange with the heat exchangers 134 and 136 may be any exothermal members.

The cooling liquid secondary circuit 130 includes a valve 138 provided with a first port 138A connected to the output of the second evaporator 28, via the pump 132, a second port 138B connected to an input of the first secondary heat exchanger 134, and a third port 138C connected to an input of the second secondary heat exchanger 136.

The first and second evaporators 26 and 28 are connected in series. These evaporators 26 and 28 may be integrated in a common module or else they may be separate from each other.

In the third embodiment shown in FIG. 3, the second evaporator 28 is disposed downstream from the first evaporator 26 in the refrigerant fluid circulation direction in the main circuit 14.

Furthermore, it should be observed in this third embodiment that the first evaporator 26 and the second evaporator 28 are arranged in the compartment C2. However, both secondary heat exchangers 134 and 136 are disposed in the compartment C3 of the vehicle that is distinct from its cabin.

The main aspects of operation of the third embodiment of the temperature regulation device 10 are described below.

c) Operation of the Temperature Regulation Device 10 in Cold Conditions

On starting the vehicle, the exothermal members in the exchange with the heat exchangers 134, 136 do not need to be cooled since their temperature is low enough. Similarly, the vehicle cabin does not need to be cooled.

As a result, the heat pump 12 and the pump 132 of the coolant liquid secondary circuit 130 are deactivated.

After the electric motor of the vehicle has been operating for a certain length of time, the temperature of the exothermal members in heat exchange with the heat exchangers 134, 136 rises. The heat pump 12 and the pump 132 of the secondary circuit 130 are then activated. The valve 138 is adjusted in such a manner as to enable each exothermal member to be cooled in accordance with its requirements. The compressor 20 operates at a low rate that is sufficient for extracting the heat that comes from the exothermal members and from the secondary circuit 130 via the hot source 18 of the heat pump.

Where necessary, the compressor 20 operates at a faster rate so as to enable the cabin to be cooled via a first evaporator 26 disposed in the cabin.

d) Operation of the Temperature Regulation Device 10 in Hot Conditions

Under such circumstances, the compressor 20 generally operates at a high rate so as to cool firstly the cabin via the first evaporator 26 and secondly the exothermal members via the second evaporator 28.

If during operation of the vehicle it is no longer necessary to cool the exothermal members, the pump 132 is deactivated.

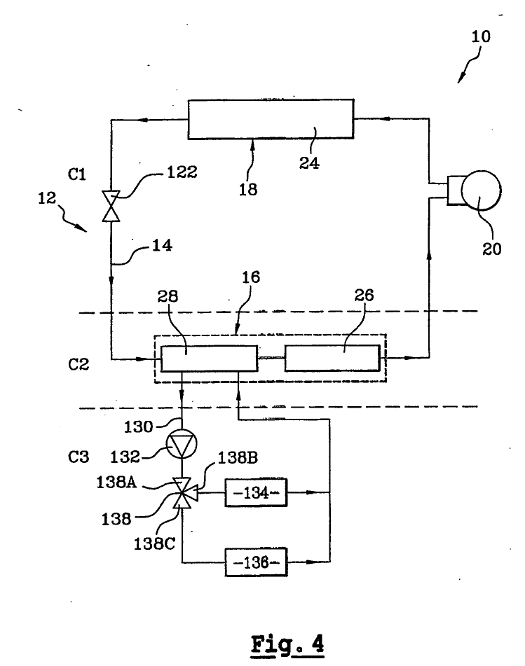

In the fourth embodiment, as shown in FIG. 4, the second evaporator 28 is disposed upstream from the first evaporator 26 so as to optimize the cooling of the exothermal members in the exchange with the heat exchangers 134, 136.

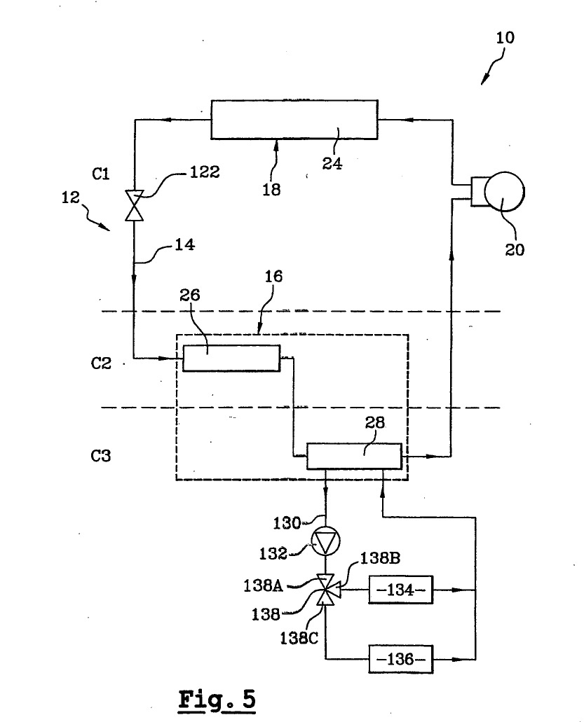

In the fifth embodiment, shown in FIG. 5, the second evaporator 28 is disposed in the compartment C3 that is distinct from the cabin, forming an engine compartment or a compartment disposed beneath a cabin floor of the vehicle.

Placing the second evaporator 28 in the engine compartment makes it easier to integrate the temperature regulation device 10 of the invention in a conventional vehicle by avoiding any need to modify significantly the configuration of the already-existing means for air conditioning the vehicle cabin.

Naturally, a combination of the various embodiments of the invention as described above is possible without going beyond the ambit of the invention.

Amongst the advantages of the invention, it should be observed that the secondary coolant liquid circuit 103 coupled to the heat pump 12 by the second evaporator 28 enables the battery and the electronic power device of an electrical or hybrid vehicle to be cooled effectively. As a result, the maximum temperature of the battery can be restricted to 45° C., thereby enabling battery lifetime to be increased, in particular by one-third compared with the normal lifetime. Furthermore, the temperature of the coolant liquid in heat exchange with the electronic power device can be lowered by about 40° C. compared with a conventional temperature regulation device, thus enabling the volume of said electronic power device to be reduced by about 1 liter.

In hot conditions, the secondary coolant liquid circuit 130 thermally coupled to the cold source 16 of the heat pump enables the temperature of the battery to be reduced quickly so as to stabilize it to the value of about 45° C., thereby guaranteeing a relatively long lifetime for the battery.

The invention is not limited to the embodiments described above. In particular, each secondary heat exchanger may be in heat exchange with any heat source of the vehicle, for example a fuel cell, or a heat source other than an exothermal member, for example air for supercharging a vehicle engine.

Under such circumstances, the engine is generally supercharged by means of a turbocompressor unit provided firstly with a turbine driven by the exhaust gases of the engine and disposed downstream from the engine, and secondly by an air admission compressor disposed upstream from the engine. The air admitted to the engine is heated in the compressor and can be cooled on leaving the compressor by a secondary heat exchanger of the device of the invention so as to optimize the performance of the engine and minimize the emission of pollution.

1-16. (canceled)

17. A temperature regulation device of a motor vehicle, the device comprising a heat pump including a main refrigerant fluid circuit comprising a main refrigerant fluid that transfers heat from a cold source to a hot source, the cold source comprising a first evaporator connected in parallel to a second evaporator, the first evaporator adapted to exchange heat between refrigerant fluid and air, the second evaporator adapted to exchange heat between refrigerant fluid and a coolant liquid, the main refrigerant fluid circuit thermally coupled to a secondary coolant liquid circuit capable of being connected to at least one secondary heat exchanger adapted to exchange heat with at least one heat source of the vehicle.

18. The device of claim 17, wherein the device includes a plurality of secondary cooling liquid circuits connected to respective heat sources.

19. The device of claim 18, wherein the secondary heat exchangers are connected in parallel.

20. The device of claim 17, wherein the main refrigerant fluid circuit comprises first and second parallel evaporator branches connected respectively to the first and second evaporators, each evaporator branch including an expansion valve.

21. The device of claim 20, wherein the first evaporator branch includes a regulator valve for regulating fluid flow rate.

22. The device of claim 21, wherein the main refrigerant fluid in the main refrigerant fluid circuit flows from an upstream position to a downstream position, and the valve is disposed downstream from the first evaporator.

23. The device of claim 21, wherein a single member comprises the expansion valve and the regulator valve.

24. The device of claim 17, wherein the secondary cooling liquid circuit includes a circulation pump for moving the cooling liquid.

25. The device of claim 17, wherein the hot source includes a condenser including a refrigerant fluid/air heat exchanger.

26. The device of claim 25, wherein the condenser is disposed in an engine compartment of the vehicle.

27. The device of claim 17, wherein the first evaporator is disposed in a cabin of the vehicle.

28. The device according to claim 17, wherein the second evaporator is disposed in a portion of the vehicle that is distinct from a cabin of the vehicle.

29. The device of claim 18, wherein each secondary heat exchanger is disposed in a portion of the vehicle that is distinct from a cabin of the vehicle.

30. The device of claim 17, wherein the hot source comprises an exothermal member of the vehicle.

31. The device of claim 30, wherein the exothermal member is selected from the group consisting of an electronic power device, a power supply battery for an electrical vehicle drive motor, a fuel cell, and the air for supercharging a heat engine of the vehicle.

32. The device of claim 17, wherein the refrigerant fluid of the main circuit comprises R134a type fluid.

33. The device of claim 17, wherein the refrigerant fluid of the main circuit comprises carbon dioxide.

34. The device of claim 33, wherein the main refrigerant fluid flows from an upstream position through a compressor to a downstream position through a condenser, and the main circuit includes an intermediate heat exchanger passing both an upstream branch of the main circuit upstream from the compressor and a downstream branch of the main circuit downstream from the condenser.

35. The device of claim 1, wherein the secondary coolant liquid circuit includes a coolant liquid comprising water and antifreeze.
